(19) United States
(12) Patent Application Publication
(10) Pub. No.: US 2006/0244328 A1
(43) Pub. Date: Nov. 2, 2006

(54) Brush motor having coreless assembly

(76) Inventors: Dong-liang Guo, Jiaxing City (CN); Kang Lu, Jiaxing City (CN); Min-Huang Lin, Jiaxing (CN); Ta-Chun Song, Jiaxing City (CN)

Correspondence Address: TROXELL LAW OFFICE PLLC, SUITE 1404, 5205 LEESBURG PIKE, FALLS CHURCH, VA, 22041, US

(21) Appl. No.: 11/117,374

(22) Filed: Apr. 29, 2005

(51) Int. Cl. H02K 21/26; H02K 21/38

(52) U.S. Cl. 310/154.06; 310/237; 310/68 B

(57) ABSTRACT

The present invention provides a coreless brush motor of simple structure with high usage efficiency, no copper loss and small mechanical loss.

### FIELD OF THE INVENTION

The present invention relates to a brush motor; more particularly, relates to a brush motor with simple structure, high usage efficiency, no copper loss and small mechanical loss.

### DESCRIPTION OF THE RELATED ART

The efficiency of a DC motor according to a prior art depends on its copper loss as well as its mechanical loss. The copper loss is a loss happened when a current is passing through an armature and can be obtained by the resistance and the current rating of the armature. The rotor can be stuck by the resistance of the armature to be prevented from rotating, while the two ends of the armature are connected to a DC power supplier. The power supplied can be getting greater till the current of the armature reaches its current rating, where the resistance of the armature is the ratio of the applied voltage to the current of the armature. Hence, a coreless motor without a silicon steel plate is of no copper loss. Besides, when a DC motor is in an idle rotation at a speed rating, the input power is equal to the mechanical loss at that specific speed owing to its idle rotation; when it is with loads and the rotation speed of the DC motor is kept a round the rotation speed measured when without the loads, the mechanical loss is equal to the idle rotation loss. Consequently, with no silicon steel plate, a coreless motor produces no end voltage as what does with loads; and, as the current of the rotor is small, the mechanical loss is small.

Please refer to FIG. 7, which is a cross-sectional view of a coreless motor according to a prior art, disclosed in the patent of U.S. Pat. No. 3,993,920, “Coreless motor” As shown in the figure, the coreless motor comprises a case 4 with a bearing 5, a rotor 6 with a flat coil 61 and a stator 7 with a fixed field, where the stator 7 is corresponding to the rotor 6 and a rotary field is formed by using a brush 8.

Although a coreless motor can be obtained according the prior art stated above, the stator 7 of the coreless motor is corresponding to the flat coil 61 only at an end while no field stopper is corresponding to the other end of the flat coil 61. As a result, its magnetic circuit is not shortened on operating so that it produces more hysteresis loss and mechanical loss yet less usage efficiency. In addition, the structure of the rotor 6 is more complex so that it takes more working hours and working processes. So, the prior art does not fulfill users' requests on actual use.

### SUMMARY OF THE INVENTION

Therefore, the main purpose of the present invention is to obtain a motor of high power density and high rotation speed while with simple structure, high usage efficiency, no copper loss and small mechanical loss.

To achieve the above purpose, the present invention is a brush motor having coreless assembly, comprising a motor, an inverter and a control unit. Therein, the motor comprises a case; a permanent magnet is deposed on at least an inner end surface of the case; a collar plate is deposed at at least an end surface of the permanent magnet; an axle penetrates the case; a rotor plate fixed on the axle comprises a commutator together with more than a coil; the coil is passed through two opposite surfaces of the rotor plate; and, each of two brushes is respectively slid to touch with the commutator and are connected to an outside power source. The inverter is connected to the brush of the motor to control the field commutating time of the commutator. And, the control unit is located between and connected to the motor and the inverter so that a loop is formed to control the rotation speed of the motor. Accordingly, a novel brush motor having coreless assembly is obtained.

### BRIEF DESCRIPTION OF THE DRAWINGS

The present invention will be better understood from the following detailed descriptions of the preferred embodiments according to the present invention, taken in conjunction with the accompanying drawings, in which

FIG. 1 is a perspective view according to the present invention;

FIG. 2 is an explosive view of a preferred embodiment of a motor according to the present invention;

FIG. 3 is a cross-sectional view of the preferred embodiment of a motor according to the present invention;

FIG. 4 is a cross-sectional view of another preferred embodiment of a motor according to the present invention;

FIG. 5 is a view of an open loop control according to the present invention;

FIG. 6 is a view of a close loop control according to the present invention; and

FIG. 7 is a cross-sectional view of a coreless motor according to a prior art.

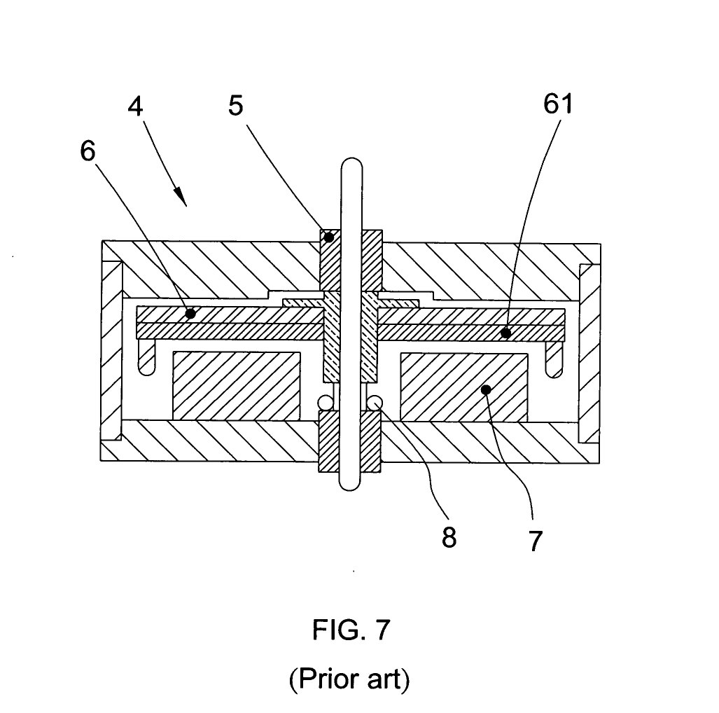

### DESCRIPTION OF THE PREFERRED EMBODIMENTS

The following descriptions of the preferred embodiments are provided to understand the features and the structures of the present invention.

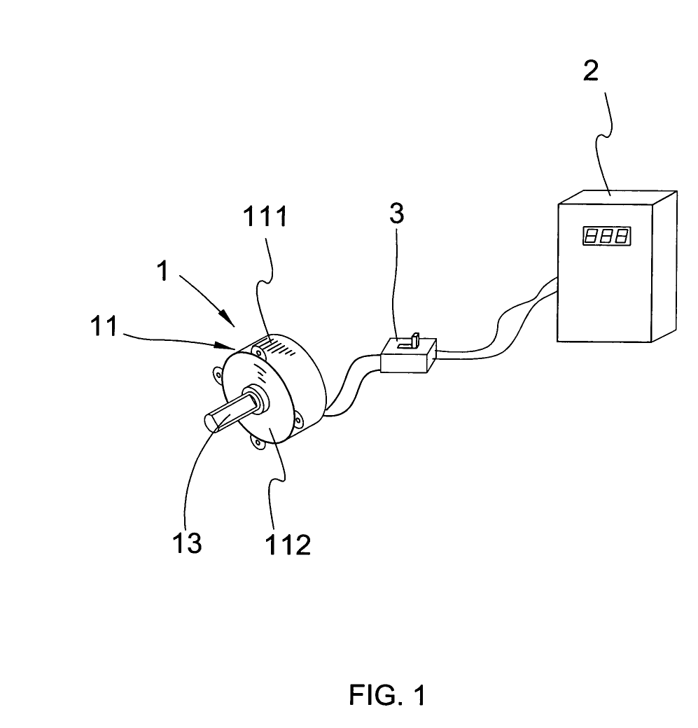

Please refer to FIG. 1, which is a perspective view according to the present invention. As shown in the figure, the present invention is a brush motor having coreless assembly, comprising a motor 1, an inverter 2, and a control unit 3, where the motor 1 has characteristics of high power density and high rotation speed while its structure is simple, its usage efficiency is high, and it is of no copper loss as well as of a small mechanical loss.

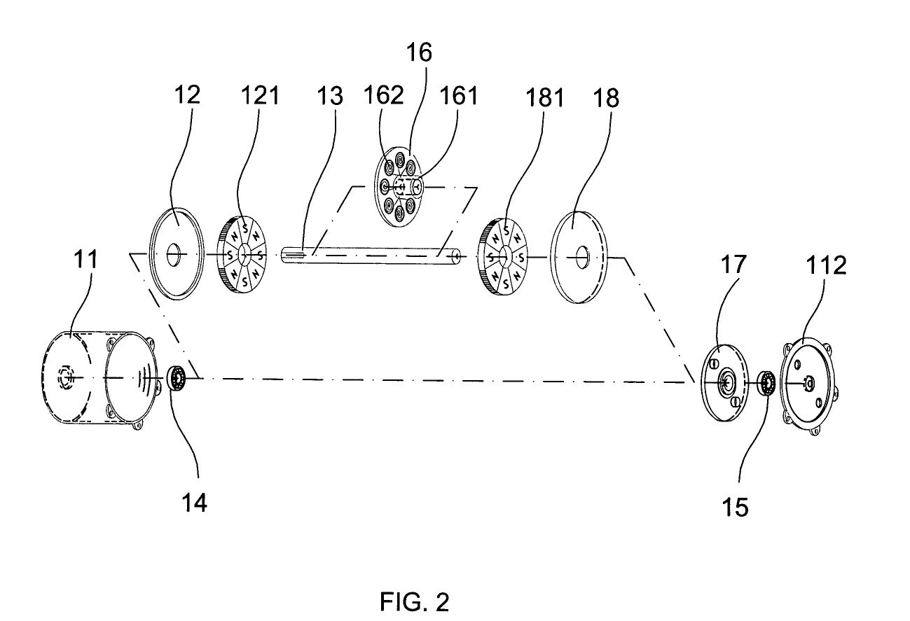

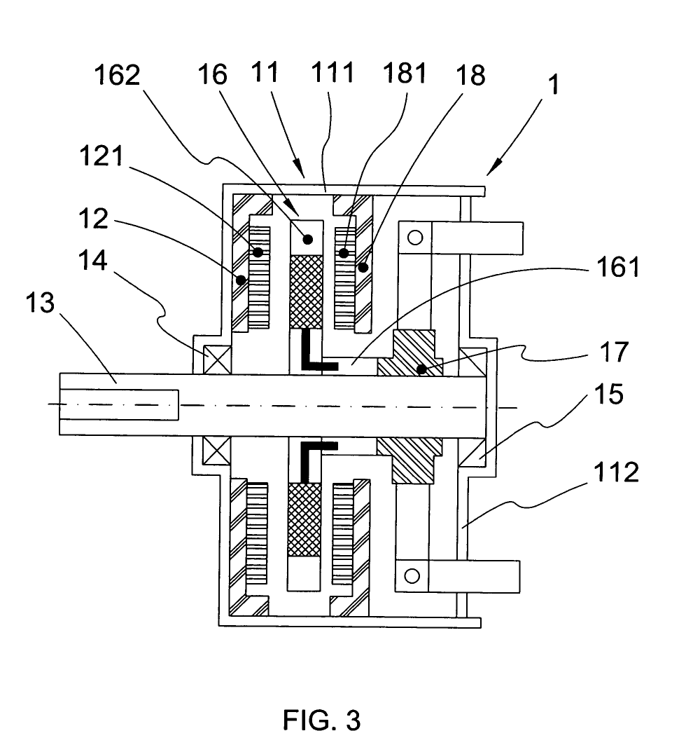

Please refer to FIG. 2 and FIG. 3 as well, which are an explosive view and a cross-sectional view of a motor of a preferred embodiment according to the present invention. As shown in the figures, the motor 1 comprises a case 11 a collar plate 12, 18, an axle 13, a bearing 14, 15, a rotor plate 16 and a brush 17. The case 11 comprises a metal container 111 and a cover 112 covered on the metal container 111, where a permanent magnet 121, 181 is respectively deposed on each inner end surface of the metal container 111. The collar plate 12, 18 is respectively located at an end of the permanent magnet 121, 181 to keep a shortest magnetic circuit to the axle 13. The axle 13 of movability penetrates the metal container 111 and the cover 112. A bearing 14 is located between an end of the axle 13 and the metal container 111; and another bearing 15, between another end of the axle 13 and the cover 112. A rotor plate 16 comprising a commutator 161 is deposed on the axle 13. More than one coil 162 is located on the rotor plate 16; and, the coil 162 is passed through two opposite ends of the rotor plate 16. The commutator 161 is slid to be in touch with two brushes 17. The brushes 17 are connected to an outside power source (not shown in the figures). The inverter 2 is connected with the brushes 17 of the motor 1 to control the field commutating time of the commutator 161. The control unit 3 is located between and connected to the motor 1 and the inverter 2 so that a loop is formed to control the rotation speed of the motor 1. In the end, a novel brush motor having core less assembly is obtained.

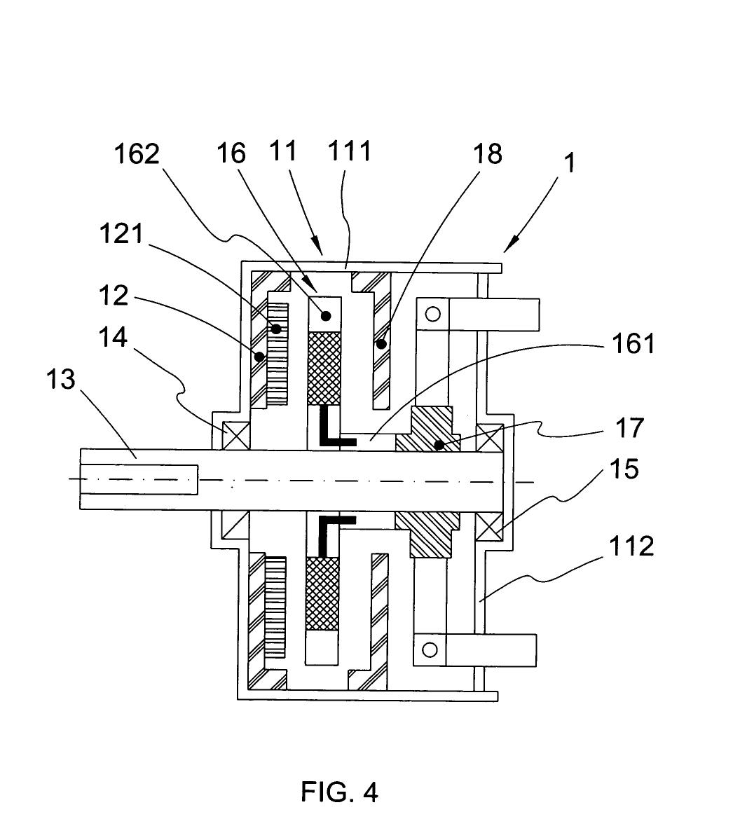

Please refer to FIG. 4, which is a cross-sectional view of a motor of another preferred embodiment according to the present invention. As shown in the figure, the motor 1 comprises a case 11, having a metal container 111 and a cover 112, with one permanent magnet 121 on at least one end surface of the case 11; an axle 13, penetrating the metal container 111 and the cover 112; a collar plate 12, 18, respectively located at an end of the permanent magnet 121 and at an end of the axle 13 to keep a shortest magnetic circuit to the axle 13; a bearings, respectively located between an end of the axle 13 and the metal container 111 and between an other end of the axle 13 and the cover 112; a rotor plate 16, fixed on the axle 13 and comprised with a commutator 161 and having more than one coil 162 deposed over a surface of the rotor plate 16; and two brushes, each respectively in touch with the commutator 161 connected to an outside power source (not shown in the figure).

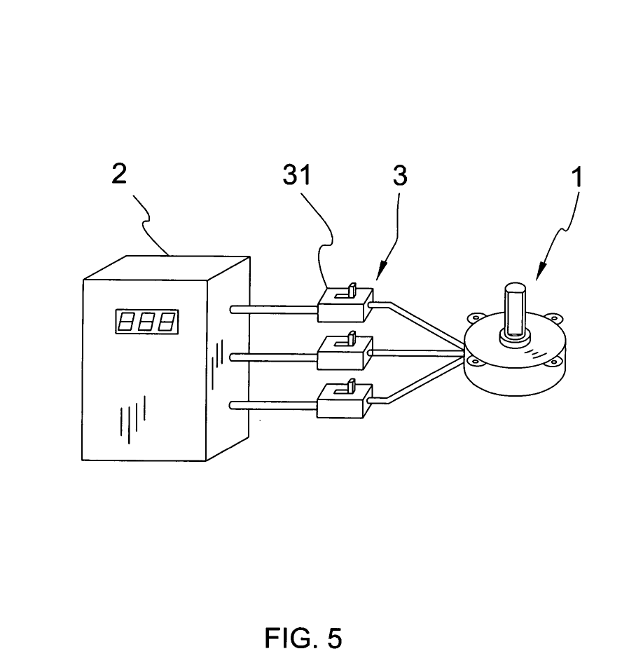

Please refer to FIG. 5, which is a view of an open loop control according to the present invention. As shown in the figure, in actual application, a control unit 3 according to the present invention can comprise a plurality of switchers 31 with a setup speed of 300 rpm (revolutions per minute), 600 rpm or 1200 rpm to control the rotation speed of a motor 1. When operating, the user turns on the required switcher 31 to form a loop between the motor 1, an inverter 2 and the switcher 31 so that the motor 1 can reach the required speed according to the setup speed of the switcher 31 the user turns on.

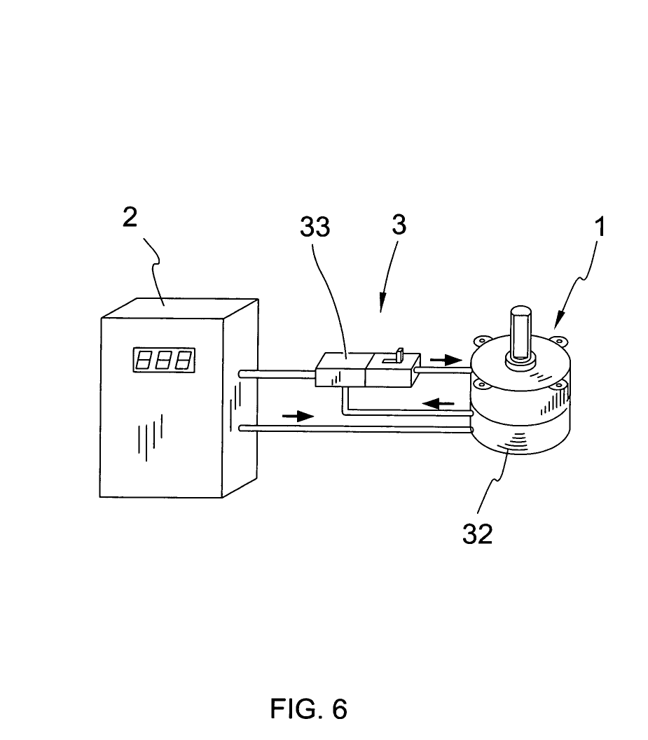

Please refer to FIG. 6, which is a view of a close loop control according to the present invention. As shown in the figure, besides forming an open loop control as shown in FIG. 5, a control unit 3 can comprises a tachometer 32 connected with an axle 13 of a motor 1 and a differential amplifier 33 connected with the switcher 31 and to an inverter 2. When operating, a value for rotation speed is setup in the differential amplifier 33. When the motor 1 is powered to be turned on, it is rotated in a speed according to the set up value. According to the rotation speed of the motor 1 reported promptly and continuously in the feedbacks of the tachometer 32 to the differential amplifier 33, the rotation speed error to the setup rotation speed is analyzed. If the error amount is getting smaller, the commutation speed is turned smaller by the inverter 2 so that the rotation speed can reach the setup value. On the contrary, if the error amount is getting bigger, the commutation speed is turned greater by the inverter 2 so that the rotation speed can reach the setup value.

To sum up, the present invention is a brush motor having core less assembly, where the motor has characteristics of high power density and high rotation speed while its structure is simple, its usage efficiency is high, and it is of no copper loss as well as of a small mechanical loss.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A brush motor having coreless assembly, comprising:
a motor, said motor comprising a case, said case comprising a permanent magnet on at least one inner end surface of said case, said case penetrated with an axle of movability, a rotor plate deposed on said axle, said rotor plate comprising a commutator and more than one coil, said coil passing through two opposite end surfaces of said rotor plate, said brush respectively slid to be in touch with said commutator, said brush connecting to an outside power source;
an inverter, said inverter connecting with said brush of said motor to control a field commutating time of said commutator; and
a control unit, said control unit located between said motor and said inverter, said control unit located between and connected to said motor and said inverter to form a loop to control a rotation speed of said motor.

2. The brush motor according to claim 1 wherein said case comprises a metal container and a cover covered on said metal container.

3. The brush motor according to claim 1 wherein a bearing is respectively located between said case and each of two ends of said axle.

4. The brush motor according to claim 1 wherein a collar plate corresponding to said rotor plate is deposed in said case.

5. The brush motor according to claim 1, wherein said control unit comprises a plurality of switchers to control a rotation speed of said motor.

6. The brush motor according to claim 1,
wherein said control unit comprises a tachometer and a differential amplifier connected with said tachometer;
wherein said differential amplifier is connected to said motor and said inverter; and
wherein said tachometer is connected with said axle of said motor.
